(19) United States
(12) Patent Application Publication
(10) Pub. No.: US 2025/0191865 A1
(43) Pub. Date: Jun. 12, 2025

(54) GROUND FAULT CIRCUIT INTERRUPTER

(71) Applicant: Jia YAO, Shenzhen (CN)

(72) Inventor: Jia YAO, Shenzhen (CN)

(21) Appl. No.: 18/427,765

(22) Filed: Jan. 30, 2024

(30) Foreign Application Priority Data
Dec. 6, 2023 (CN) 202311666634.6

(51) Int. Cl. H01H 71/02; H01H 71/10

(52) U.S. Cl. CPC H01H 71/0207; H01H 71/10

(57) ABSTRACT

The present invention discloses a ground fault circuit interrupter including a lower cover, an upper cover, a base seat, a tripping mechanism, a resetting key, a test key, a pair of movable contacts, a pair of first static contacts fixed on the base seat, a pair of second static contacts fixed on the supporting frame, a first locking mechanism and a control circuit board; the base seat includes a supporting frame, the tripping mechanism includes an elastically-movable main frame, a spring, a coil fixing frame connected to the main frame, a coil encircling said coil fixing frame, an iron core arranged inside said coil fixing frame and said coil, a horizontal sliding member fixedly connected with one end of the iron core, a permanent magnet arranged on the other end of the main frame; the movable contacts are elastically installed on the main frame.

### TECHNICAL FIELD

The present invention relates to ground fault protection devices, in particular to a ground fault circuit interrupter having a reverse connection-proof function.

### BACKGROUND ART

Because the ground fault circuit interrupter (GFCI) can effectively prevent electric shocks on a human body, leakage of electricity from electrical equipment and fire risks, it has been widely used. With the development of science and technology, there is a trend towards high performance, intelligence and multi-function in the development of the ground fault circuit interrupter, but certain limitations are posed on the reliability and stability of the previous ground fault circuit interrupter, which has high requirements for the processing and installation of parts. Therefore, it is necessary to provide a high-safety ground fault circuit interrupter, which necessarily has the characteristics such as reverse connection-proof function, sensitive action, easy assembly and more perfect use.

### SUMMARY OF THE INVENTION

The technical problem to be solved by the present invention is to provide a ground fault circuit interrupter capable of having a reverse connection-proof function and being stable and reliable, when a user accidentally reverses connection, the control circuit does not operate, thus the ground fault circuit interrupter cannot be reset; when on correct installation an user presses the resetting key, the ground fault circuit interrupter operates normally.

A technical scheme provided to solve the technical problem of the present invention is: to provide a ground fault circuit interrupter comprising a lower cover, an upper cover, a base seat arranged in the middle and the base seat including a supporting frame, wherein the ground fault circuit interrupter further comprises a tripping mechanism, a resetting key, a test key, a pair of movable contacts having contact silver points and can elastically move, a pair of first static contacts having silver contacts and are fixed on the base seat, a pair of second static contacts having silver contacts and are fixed on the supporting frame, a first locking mechanism and a control circuit board;

the tripping mechanism includes an elastically-movable main frame, a first spring, a coil fixing frame connected to the main frame by means of the first spring, a coil encircling the coil fixing frame, an iron core arranged inside the coil fixing frame and the coil, a horizontal sliding member fixedly connected with one end of the iron core, a permanent magnet arranged on the other end of the main frame, and a magnetic permeable piece surrounding the permanent magnet; the movable contacts are elastically installed on the main frame, and the contact silver points on the movable contacts are elastically connected to or disengaged from the contact silver points on the first static contacts and the contact silver points on the second static contacts, respectively;
the first locking mechanism includes a rotating piece rotatably arranged on the supporting frame and a first locking member rotatably installed on the rotating piece; one end of the first locking member is used to block the resetting key and the other end is provided with an elastic element; when the first locking member is at a blocking position, the first locking member stops the resetting key from moving downwards; when the coil conducts instantaneous current, the iron core generates magnetism and attracts the rotating piece to rotate, while the rotating piece is rotating, the rotating piece drives the first locking member to rotate and gives a way for the resetting key, the resetting key continues to move downwards and pushes the horizontal sliding member, thus the horizontal sliding member moves horizontally and compresses a second spring encircling the iron core and causes the permanent magnet to attract the iron core; at the time of removing the pressure on the resetting key, the horizontal sliding member drives the main frame to move under the restoring force of the second spring encircling the iron core, and causes the movable contacts to move, so as to make electrical contact with the contact silver points on the first static contacts and the second static contacts, respectively.

As a further improvement of the present invention, the resetting key includes at least one pressing rod having an oblique plane, when the pressing rod pushes the horizontal sliding member to move, a second locking member arranged on the horizontal sliding member presses the the pressing rod to deform; at the time of removing the pressure on the resetting key, the resetting key returns to an initial position, so the second locking member stops the pressing rod from moving downwards.

As a further improvement of the present invention, a protrusion blocking and restricting the first spring and the second spring is arranged inside the coil fixing frame.

As a further improvement of the present invention, both the resetting key and the test key are sleeved with an elastic element that makes the resetting key and the test key return to their initial position.

As a further improvement of the present invention, the horizontal sliding member further includes a bump having an oblique plane that fits with the pressing rod of the resetting key.

As a further improvement of the present invention, the resetting key includes a flat for an operator's finger to press, the pressing rods having an oblique plane are respectively arranged on both sides below the flat, a pressing block is arranged between the two pressing rods, and the pressing block presses the first locking member.

As a further improvement of the present invention, an accommodating groove is arranged on the main frame, and the movable contacts are elastically arranged inside the accommodating groove.

As a further improvement of the present invention, the tripping mechanism further includes a magnetism-collecting piece closely attached to the permanent magnet, the magnetic permeable piece surrounds the permanent magnet and the magnetism-collecting piece, and the magnetic permeable piece has a bending structure and an arc-shaped structure.

As a further improvement of the present invention, the first static contacts are arranged on a plug base; the second static contacts are arranged on a load connection end.

As a further improvement of the present invention, the ground fault circuit interrupter further includes an elastic electroconductive member and an electroconductive installation piece positioned below the elastic electroconductive member, the the test key or the resetting key presses downwards the elastic electroconductive member, then the elastic electroconductive member moves downwards and makes electrical contact with the electroconductive installation piece, so as to make conduction in an entire control circuit on the control circuit board; thus a chip on the control circuit board sends out a signal to make the coil conduct instantaneous current, and then make the iron core generate magnetism.

In the more stable and reliable ground fault circuit interrupter provided by the present invention, the iron core moves linearly in the solenoid, so that the horizontal sliding member, the spring and the main frame connected with the iron core move linearly and horizontally together, thus the main frame pushes the movable contact, so as to achieve enabling the ground fault circuit interrupter to make contact and break contact; in the process from breaking contact to making contact, the force applied by the operator's hand generates movement, and the permanent magnet in a make-contact state maintains a contact force; in the process from making contact to breaking contact, the electromagnetic force generated by the electrified solenoid is greater than the attractive force of the permanent magnet to the iron core, causing the iron core and the main frame to move in opposite directions.

At a break-contact position, because the end of the rotating piece is arranged against the iron core, the distance between the rotating piece capable of rotation and the iron core is close to zero, thereby reducing magnetic resistance. Then, press the resetting key to move down, enabling the resetting key to press downwards the elastic electroconductive member and contact the electroconductive installation piece, so as to make an electrical connection, so that the control circuit is in a make-contact state, if the input end and the load end are connected up incorrectly, the coil cannot be electrified, thus the resetting key is blocked by the first locking member, and the first locking member is blocked by the blocking bar on the base seat, so it cannot continue to move down, neither push the horizontal sliding member. If the input end and the load end are connected up correctly, the coil is electrified, and during electrifying the coil, the iron core generates magnetism, thus attracts the rotating piece to rotate, so the first locking member that once blocked the resetting key to move downwards gives a way to downward movement for the resetting key; in this process, no displacement occurs to the iron core and the horizontal sliding member.

In the ground fault circuit interrupter provided by the present invention, as the magnetism-collecting piece is added and the magnetic permeable piece is bent and designed to be arc-shaped, such structure can reduce magnetic resistance, greatly decrease the volume of the permanent magnet and lower costs.

In the case that the ground fault circuit interrupter is at a make-contact position, there is a stopping block on the horizontal sliding member to hinder the resetting key from sliding downwards. This feature ensures stable and reliable contact of the ground fault circuit interrupter (GFCI) and prevents accidental contact with the resetting key during use, thereby making the contact force smaller (poor contact, ignition); it also ensures that the resetting key does not slide downwards to push the control circuit switch, if the control circuit switch is on, it will electrify the coil and cause the ground fault circuit interrupter (GFCI) to break contact. In addition, the present invention realizes that the contact silver points at two ends of the movable contact are respectively connected to or disengaged from the contact silver point on the plug base and the contact silver point on the load connection end by way of pushing the main frame to drive the movable contact to move horizontally, so such contact is firm, safe and reliable.

In addition, the ground fault circuit interrupter of the present invention only needs a tripping mechanism used to break contact, and an operator presses the resetting key by hand to make contact, which is formed through mechanical interaction. Furthermore, the magnetic permeable piece is designed to bending, which narrows down the magnetic gap, and the magnetism-collecting piece is added to greatly raise an attraction force, but the identical attraction force only requires a smaller magnet.

The ground fault circuit interrupter of the present invention has the advantages such as reverse connection-proof function, no occurrence of electrifying sockets on the panel at the time of reversing connection, rapid tripping, strong anti-interference, operational convenience, structural reasonability and low costs.

### BRIEF DESCRIPTION OF THE DRAWINGS

FIG. 1 is a perspective view of the ground fault circuit interrupter of the present invention.

FIG. 2 is another perspective view of the ground fault circuit interrupter of the present invention.

FIG. 3 is an exploded view of the ground fault circuit interrupter of the present invention.

FIG. 4 is another exploded view of the ground fault circuit interrupter of the present invention.

FIG. 5 is an exploded view of the ground fault circuit interrupter of the present invention without the upper cover, the lower cover and the installation piece.

FIG. 6 is a partial perspective view of the ground fault circuit interrupter of the present invention without the upper cover, the lower cover, the installation piece and the base seat.

FIG. 7 is another partial perspective view of the ground fault circuit interrupter of the present invention without the upper cover, the lower cover, the installation piece and the base seat.

FIG. 8 is a first local perspective view of the internal partial elements of the ground fault circuit interrupter of the present invention.

FIG. 9 is a second local perspective view of the internal partial elements of the ground fault circuit interrupter of the present invention.

FIG. 10 is a third local perspective view of the internal partial elements of the ground fault circuit interrupter of the present invention.

FIG. 11 is an exploded view of the tripping mechanism and the first locking mechanism of the ground fault circuit interrupter of the present invention.

FIG. 12 is another exploded view of the tripping mechanism and the first locking mechanism of the ground fault circuit interrupter of the present invention.

FIG. 13 is an exploded view of the tripping mechanism of the ground fault circuit interrupter of the present invention.

FIG. 14 is an assembly diagram of the tripping mechanism of the ground fault circuit interrupter of the present invention.

FIG. 15 is a perspective view of the resetting key of the ground fault circuit interrupter of the present invention.

FIG. 16 is another perspective view of the resetting key of the ground fault circuit interrupter of the present invention.

FIG. 17 is a local perspective view of the ground fault circuit interrupter of the present invention.

FIG. 18 is another local perspective view of the ground fault circuit interrupter of the present invention.

FIG. 19 is a cross-sectional view of the coil-fixing frame and two springs of the ground fault circuit interrupter of the present invention before installation.

FIG. 20 is a cross-sectional view of the coil-fixing frame and two springs of the ground fault circuit interrupter of the present invention after installation.

FIG. 21 is a top view of the ground fault circuit interrupter of the present invention.

FIG. 22 is a cross-sectional view of FIG. 21 in the A-A direction in an initial break-contact state.

FIG. 23 is a cross-sectional view of FIG. 21 in the B-B direction in an initial break-contact state.

FIG. 24 is a cross-sectional view of FIG. 21 in the A-A direction at the start of pressing the resetting key.

FIG. 25 is a cross-sectional view of FIG. 21 in the B-B direction at the start of pressing the resetting key.

FIG. 26 is a cross-sectional view of FIG. 21 in the A-A direction during continuously pressing the resetting key and in an unlock state of the first locking member.

FIG. 27 is another cross-sectional view of FIG. 21 in the A-A direction during continuously pressing the resetting key and in an unlock state of the first locking member.

FIG. 28 is a cross-sectional view of FIG. 21 in the B-B direction during continuously pressing the resetting key and in an unlock state of the first locking member.

FIG. 29 is a cross-sectional view of FIG. 21 in the A-A direction in a release state of the resetting key and during blocking the first locking member.

FIG. 30 is a cross-sectional view of FIG. 21 in the B-B direction in a release state of the resetting key and during blocking the first locking member.

FIG. 31 is a cross-sectional view of FIG. 21 in the A-A direction at the time of pressing the test key.

FIG. 32 is a cross-sectional view of FIG. 21 in the B-B direction at the time of pressing the test key.

FIG. 33 is a completely-exploded view of the ground fault circuit interrupter of the present invention.

FIG. 34 is a perspective view of the pressing rod of the resetting key of the ground fault circuit interrupter of the present invention before pushing the horizontal sliding member.

FIG. 35 is a perspective view shows that the pressing rod of the resetting key pushes the horizontal sliding member to an end position.

FIG. 36 is a side view shows that the pressing rod of the resetting key pushes the horizontal sliding member to an end position.

### DETAILED DESCRIPTION OF SOME EMBODIMENTS

We shall describe the technical solution of the present invention in detail in combination with the drawings and specific examples as follows, so as to enable the essence of the present invention to be understood more clearly and intuitively. It should be understood that the following specific examples are only used to explain the present invention and are not intended to pose any limitations on the protection scope of the present invention. It should be noted that the terms “front”, “back”, “left”, “right”, “top” and “bottom” used in the following description refer to the direction in the drawing, and the terms “inside” and “outside” refer to the direction towards or outwards from the geometric center of a particular part, respectively.

At present, because the ground fault circuit interrupter can effectively prevent electric shocks on a human body and damage to equipment caused by a ground fault, it has been widely used.

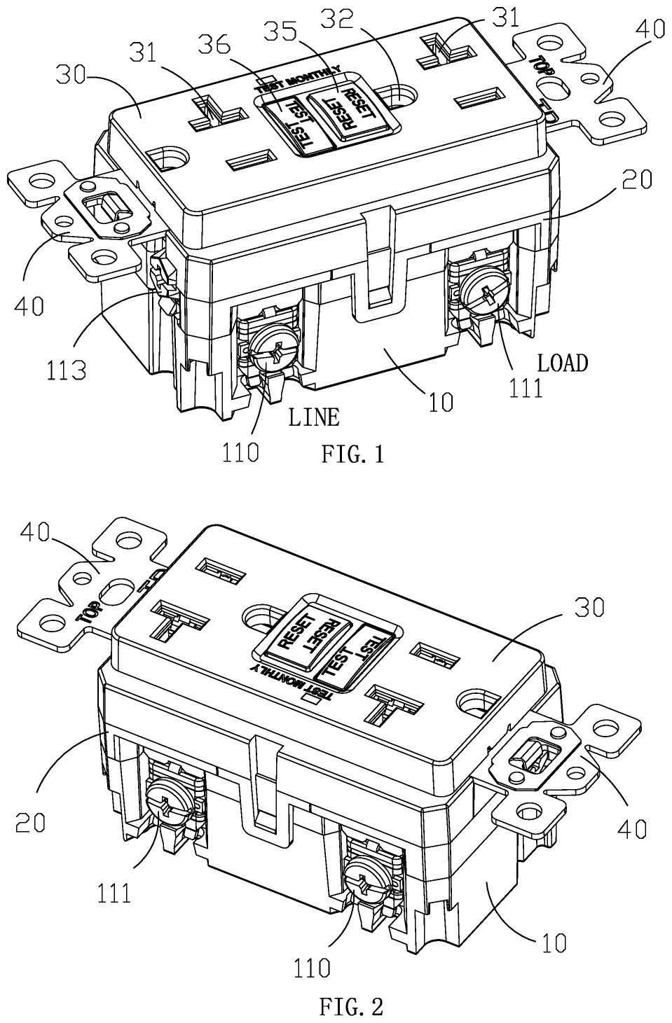

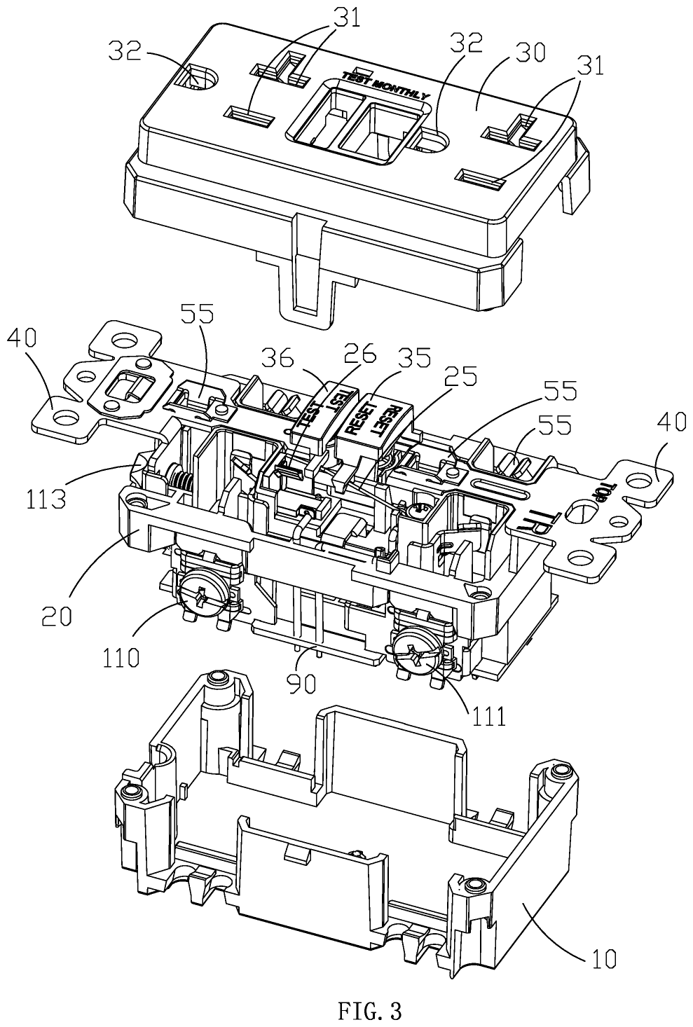

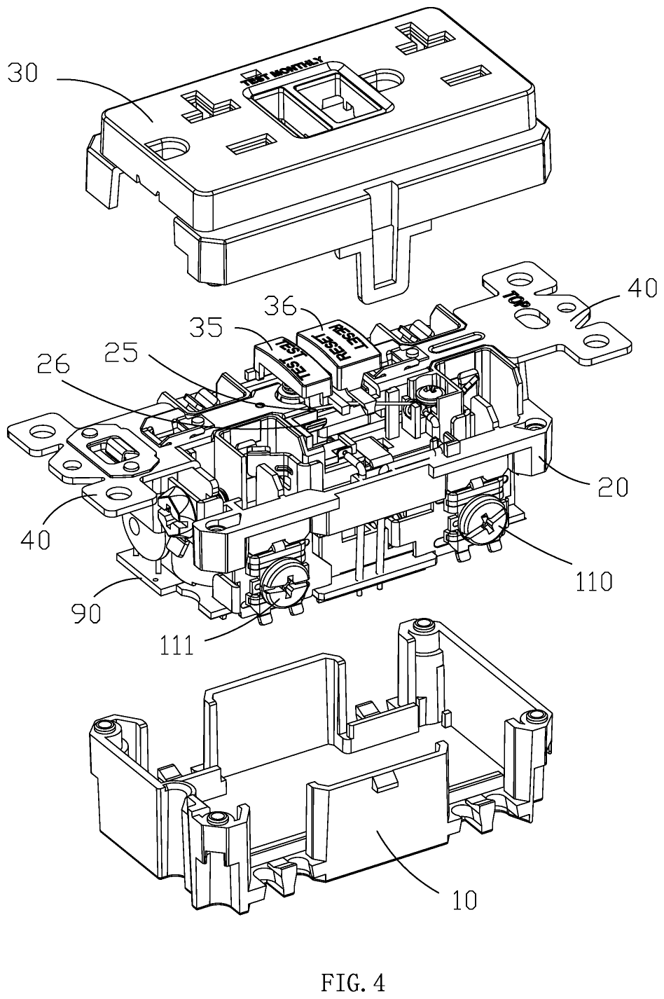

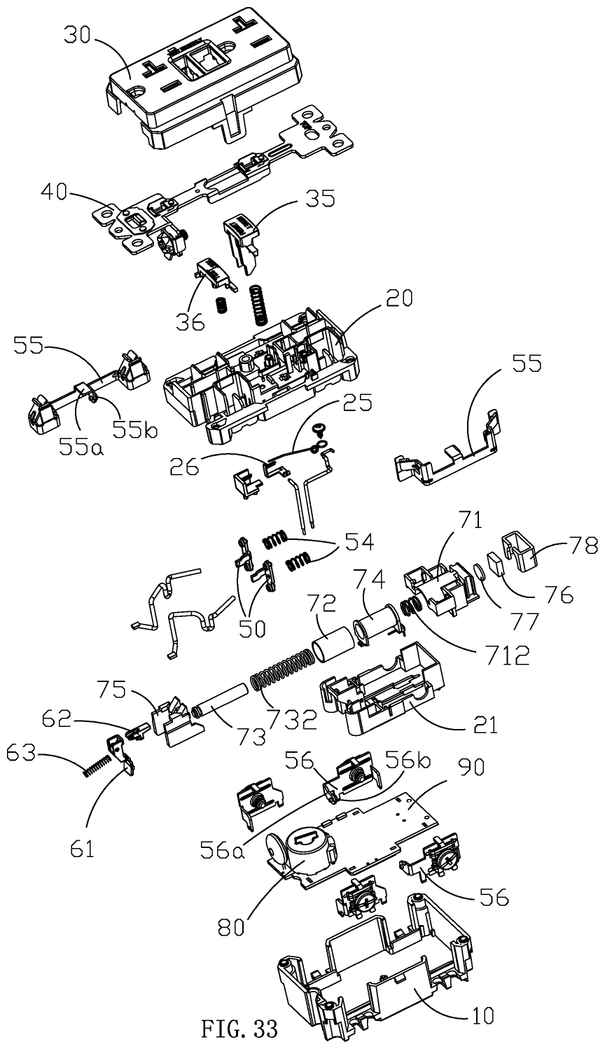

As shown in FIGS. 1-4 and 33, the more stable and reliable ground fault circuit interrupter provided by the present invention includes the lower cover 10, the upper cover 30 with a socket, the base seat 20 arranged in the middle, the tripping mechanism, the resetting key 35 (RESET key), the test key 36 (TEST key), the installation piece 40 with an earthing end and an earthing screw, a pair of movable contacts 50 with the contact silver points 52, a pair of static contacts 55a with the silver contacts 55b and arranged on the plug base 55, a pair of static contacts 56a with the silver contacts 56b and arranged on the load connection end 56, and the control circuit board 90. The ground fault circuit interrupter further includes the power source connection screw 110, the load connection screw 111 and the earthing screw 113. The load power source socket 31 and the circular earthing socket 32 are arranged on the upper cover 30.

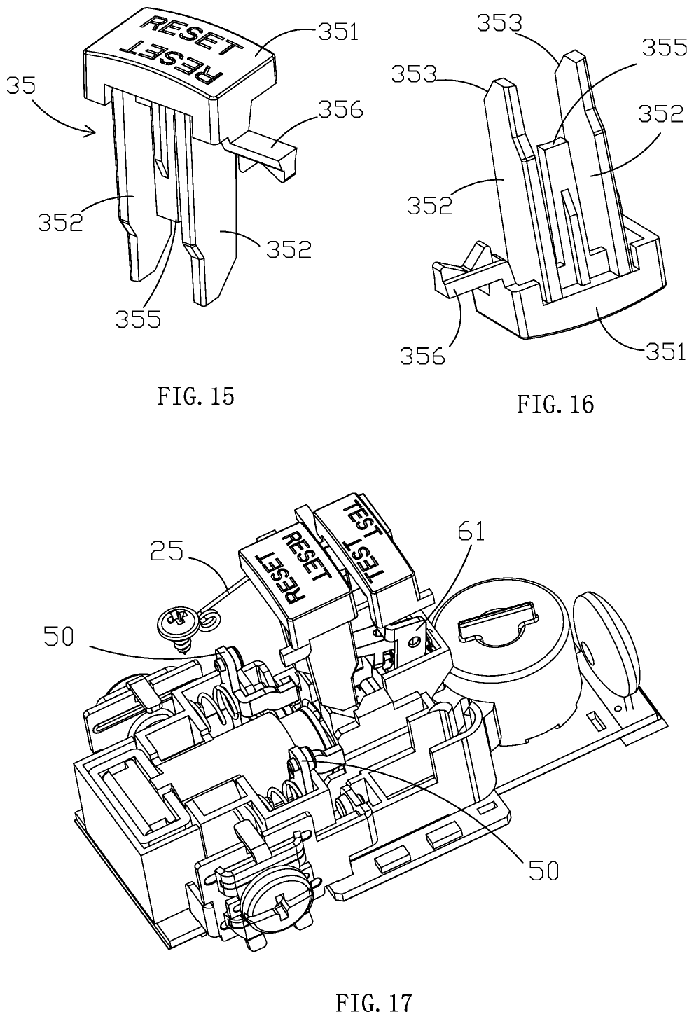

As shown in FIGS. 15-16, the resetting key 35 is arranged on the base seat 20 together with the upper cover 30, having the flat 351 for the operator to press it with fingers, and the outer surface of the flat 351 is provided with the English letter “RESET”, the pressing rods 352 having the oblique plane 353 are arranged on both sides below the flat 351, the long strip-like pressing block 355 is arranged between the two pressing rods 352, the resetting key 35 is also sleeved with a spring, which makes the resetting key 35 return to its initial position after releasing the pressure on it. A pressing rod is arranged on the lower part of the test key 36, which is also sleeved with a spring, and this spring makes the test key 36 return to the initial position after releasing the pressure on it.

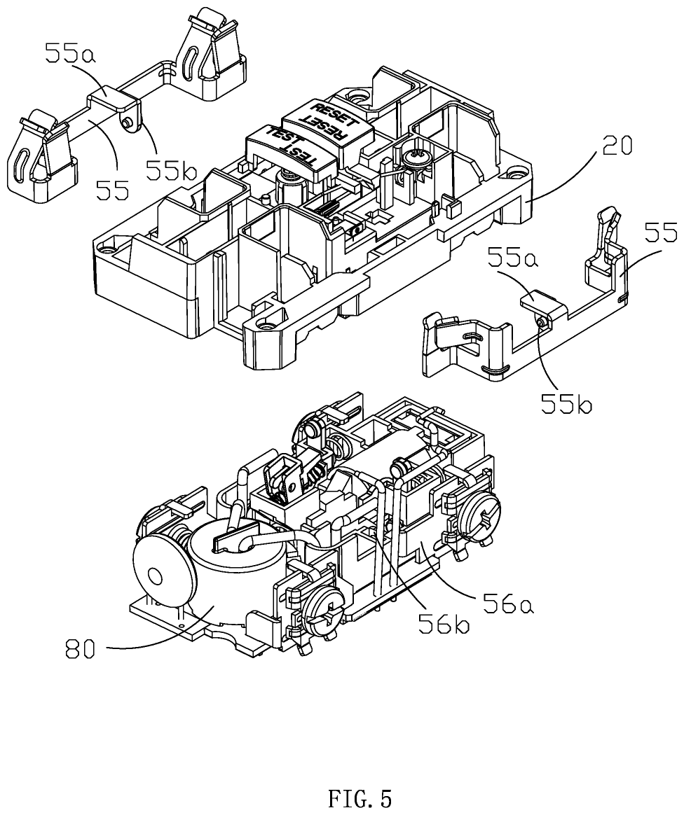

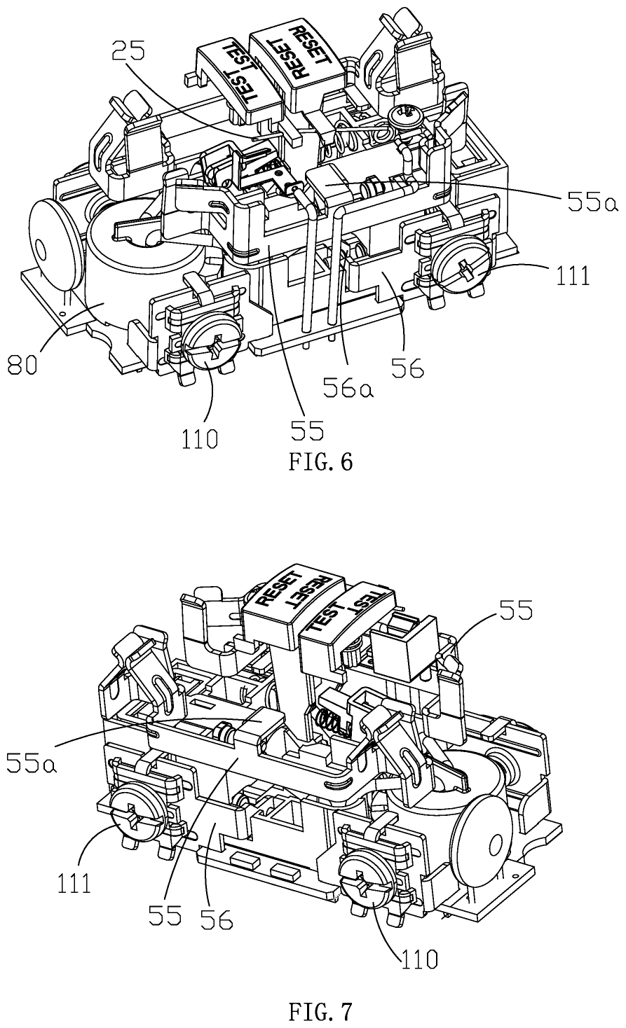

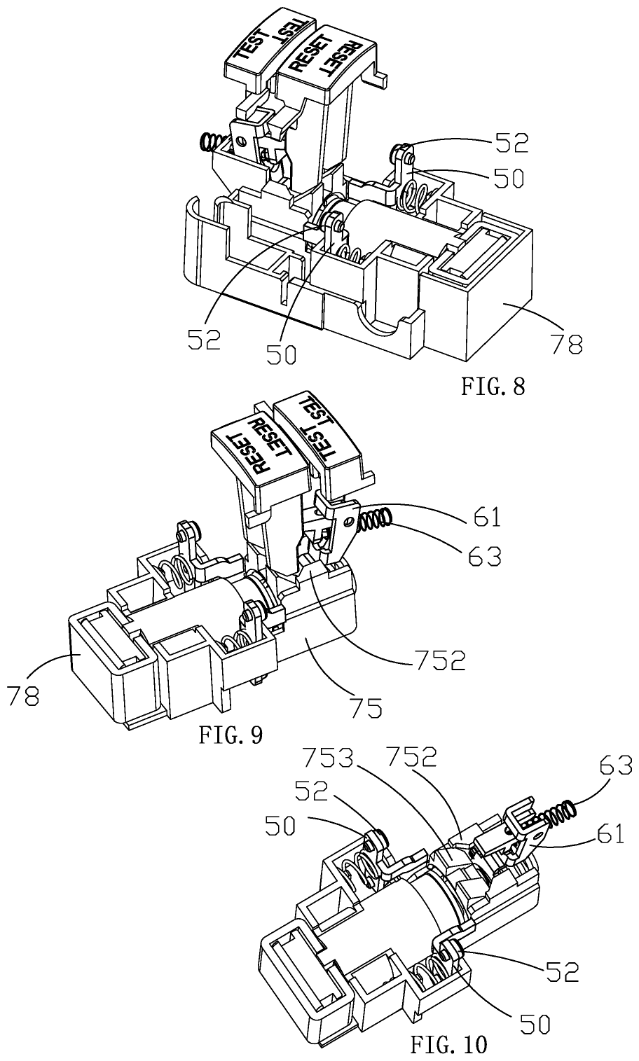

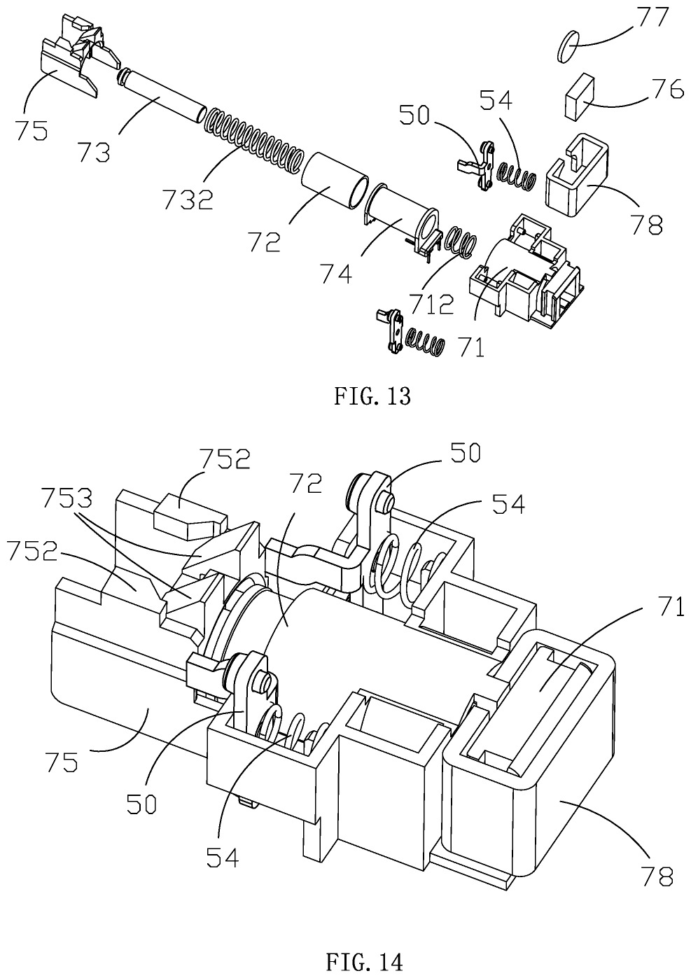

As shown in FIGS. 5-14, the tripping mechanism is arranged inside the supporting frame 21 on the base seat 20. The tripping mechanism includes the movable main frame 71, the spring 712 arranged inside the main frame 71 and making the main frame 71 elastically move, the coil fixing frame 74 fixed on the supporting frame 21, the coil 72 (or called a solenoid) encircling the coil fixing frame 74, the iron core 73 arranged inside the coil fixing frame 74 and the coil 72, the spring 732 encircling the iron core 73 and the horizontal sliding member 75 fixedly connected with one end of the iron core 73, wherein one end of the spring 732 is arranged against the horizontal sliding member 75, and the other end is arranged against the annular protrusion 742 inside the coil fixing frame 74, so that the horizontal sliding member 75 moves horizontally and compresses the spring 732 and returns to the initial position under the restoring force of the spring 732. The main frame 71 partially covers the coil fixing frame 74 and the coil 72, and the permanent magnet 76, the magnetism-collecting piece 77 closely attached to the permanent magnet 76, as well as the magnetic permeable piece 78 that surrounds the other end of the main frame 71, the permanent magnet 76 and the magnetism-collecting piece 77 and locates the permanent magnet 76 and the magnetism-collecting piece 77, are installed on the other end of the main frame 71. The magnetic permeable piece 78 has a bending structure and an arc-shaped structure, which can reduce magnetic resistance.

Wherein, the left and right sides of the horizontal sliding piece 75 are symmetrical, and join together at the middle through the bump 753 with an oblique plane, further a pair of upwards-convex stopping blocks 752 (or called a second locking member) are also arranged on the symmetrical two sides of the horizontal sliding piece 75. The accommodating grooves 713 are arranged on the both sides of the main frame 71, the movable contact 50 and the spring 54 are installed inside each accommodating groove 713, so that the movable contact 50 can move horizontally inside the accommodating groove 713 or return to the initial position under the elastic force of the spring 54. The contact silver points 52 are arranged on both the upper part and the lower part of the movable contact 50 one end of the spring 712 is arranged against the annular protrusion 742, and the other end is arranged against the inside of the main frame 71, so that the main frame 71 moves elastically. The elastic force of the spring 732 is greater than the elastic force of the spring 712.

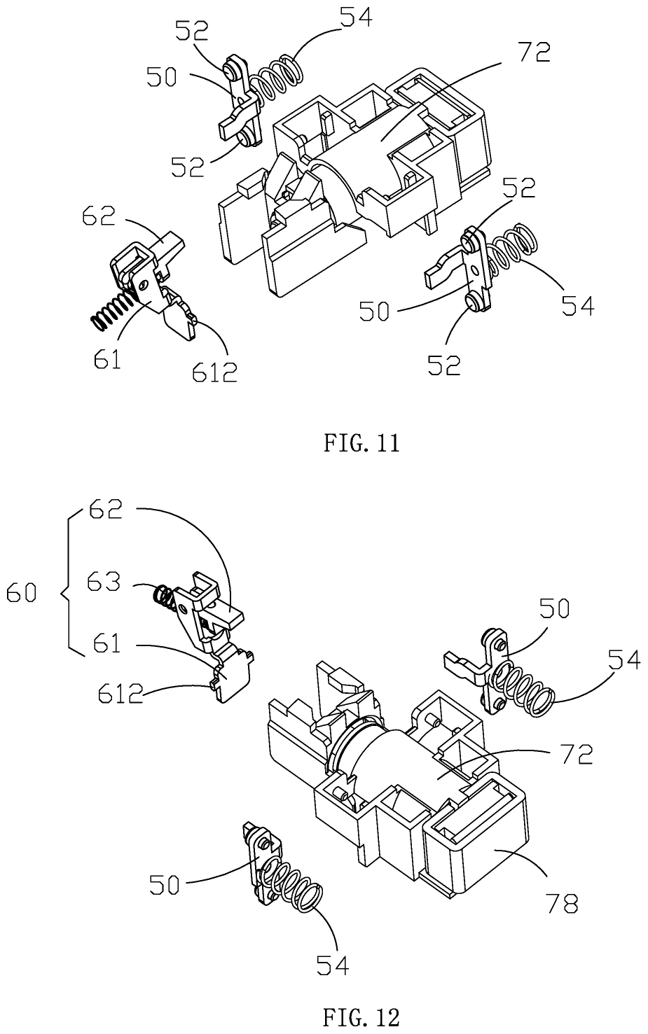

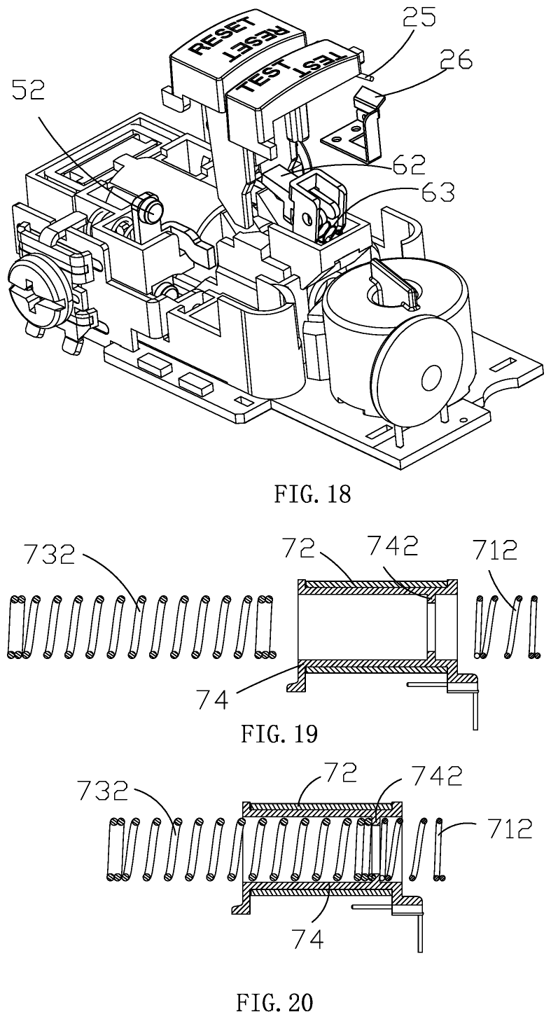

As shown in FIGS. 11-14, 17 and 18, this main frame 71 drives the movable contact 50 to move horizontally to the left under the force, so that the contact silver points 52 of the upper and lower ends of the movable contact 50 can be stably and reliably connected with the contact silver points 55b of the static contact 55a on the plug base 55 and the contact silver point 56b on the static contact 56a of the load connection end 56, respectively, and at this moment, the spring 54 connected to the movable contact 50 is compressed. In this way, this movable contact 50 enables both ends to achieve electrical contact and electrical conduction with one horizontal movement, and makes the contact force consistent and the contact stable and reliable.

As shown in FIGS. 11-12, the ground fault circuit interrupter further includes the first locking mechanism 60, which includes the rotating piece 61 rotatably arranged on the supporting frame 21 by means of the rotating shaft 612 on it, and the first locking member 62 inserted into the upper inner side of the rotating piece 61 and rotatably installed on the rotating piece 61, wherein one end of the first locking member 62 is used to block the resetting key and the other end is provided with the spring 63, of which the other end is positioned inside the supporting frame 21. When the first locking member 62 is at the blocking position, a downward pressure is applied on the first locking member 62 (a pressure generated by way of pressing the resetting key), and the first locking member 62 is blocked by the blocking bar 29 that is positioned below the first locking member and arranged on the base seat 20, thereby hindering the resetting key 35 from moving further downwards; the rotating piece 61 is attracted by the iron core 73, thus rotates counterclockwise, the rotating piece 61 pulls the spring, which pulls the first locking member 62 to rotate counterclockwise, so that the first locking member 62 is retracted and lies at an unlocking position.

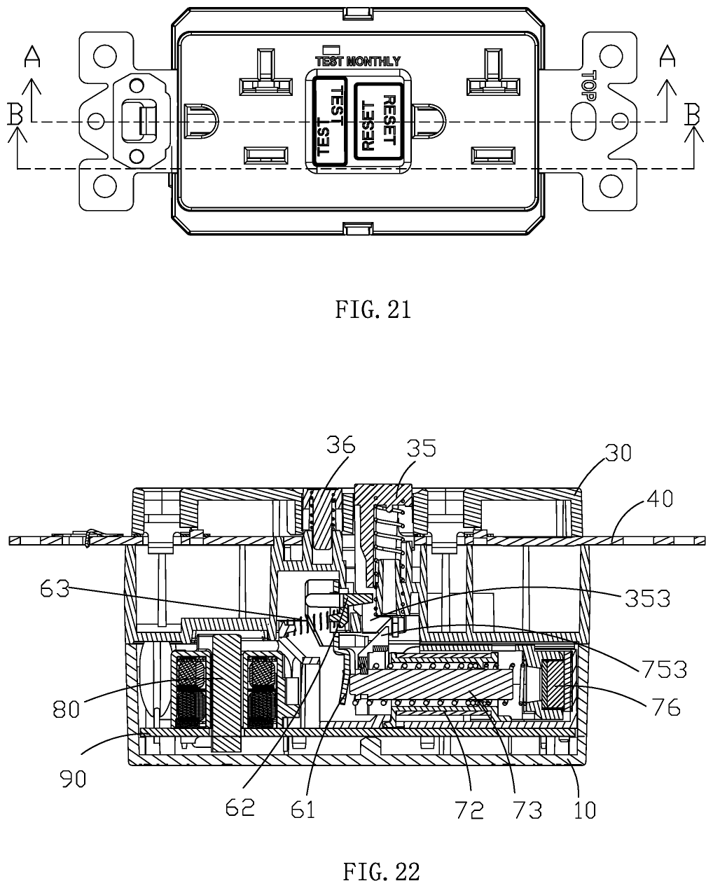

As shown in FIGS. 5-21, the ground fault circuit interrupter provided by the present invention further includes the detection coil 80 arranged on the control circuit board 90 and electrically connected with it, and the detection coil 80 is electrically connected to the movable contact 50 by means of a wire. In the case that the detection coil 80 detects leakage of electricity, if it exceeds a threshold, the processor on the control circuit board 90 can send a signal to the coil 72 (or called a solenoid) to conduct instantaneous current, so the electromagnetic force that this iron core is subjected to is greater than the attractive force of the permanent magnet to the iron core, so that the iron core moves, thereby making the ground fault circuit interrupter break contact. Since the basic principle of the detection coil 80 is the same as that of the existing detection coil, it will not be described in detail here.

In actual use, if an operator makes an incorrect connection, the first locking mechanism 60 blocks the downward movement of the pressing rod 352 of the resetting key 35, so the operator cannot press downwards the resetting key 35, which does not function, neither conduct electricity, thus the ground fault circuit interrupter does not operate. In this case, the operator is aware that a problem occurs to the connection, so as to check the connection and make a correct connection.

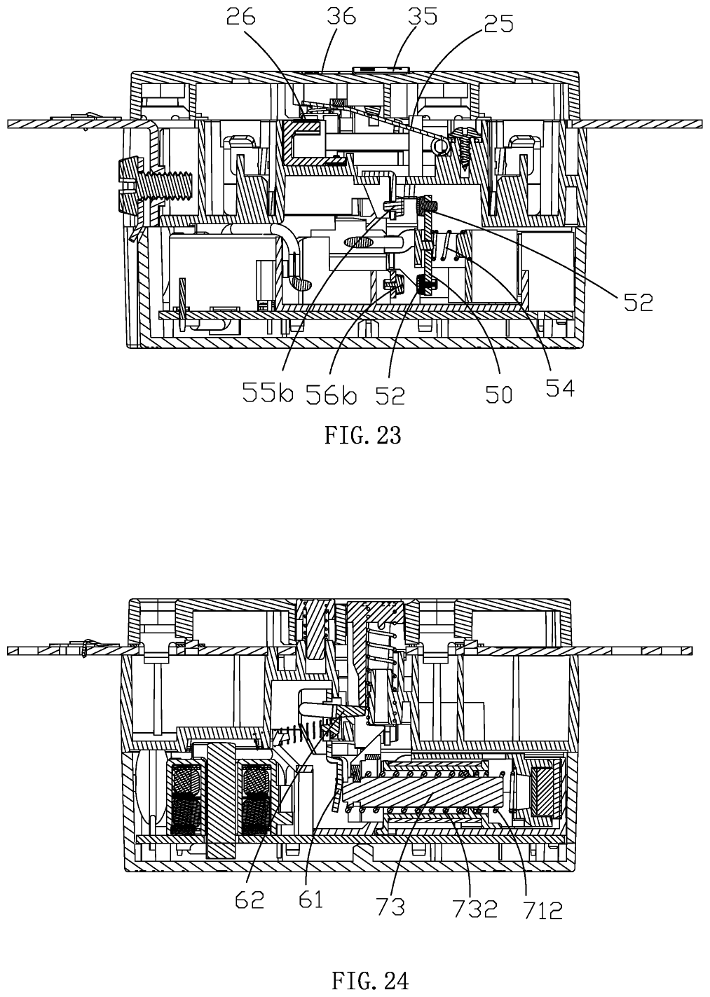

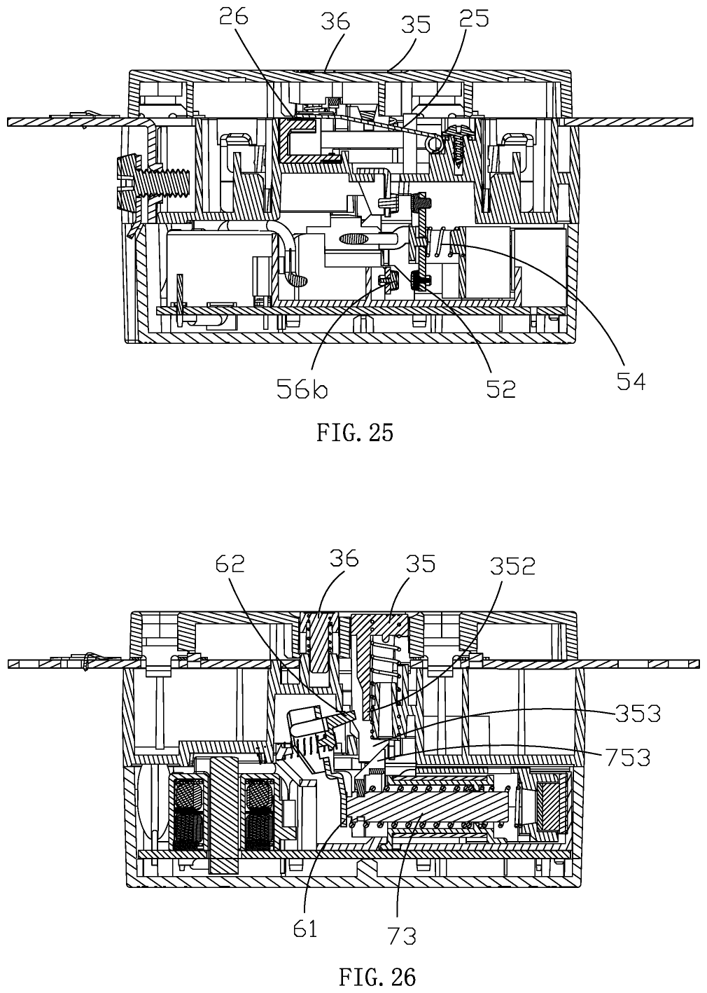

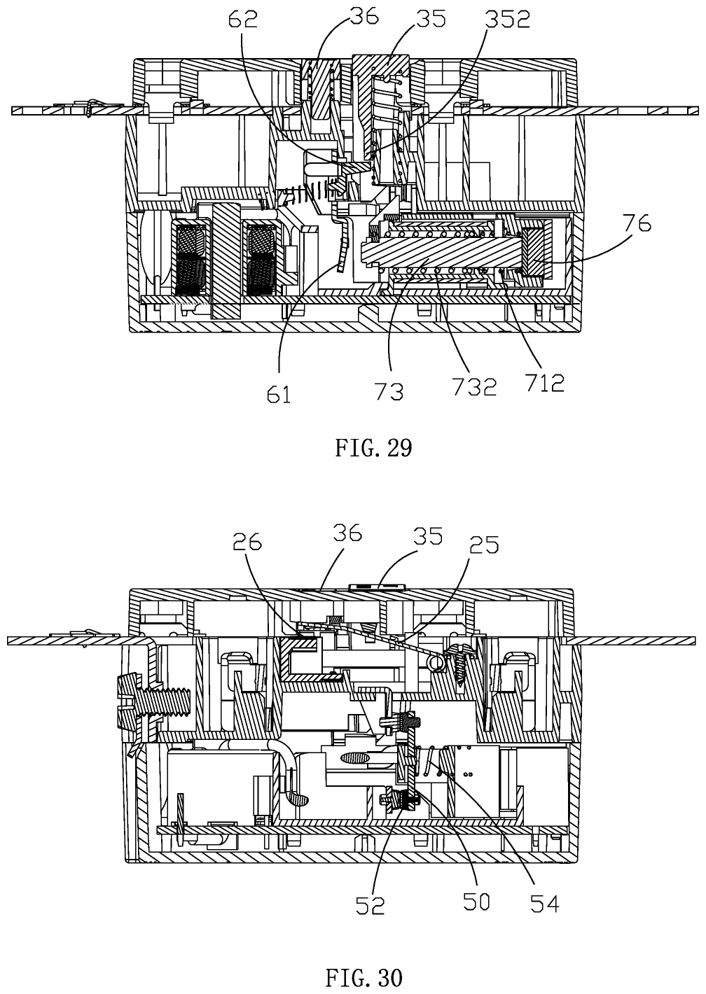

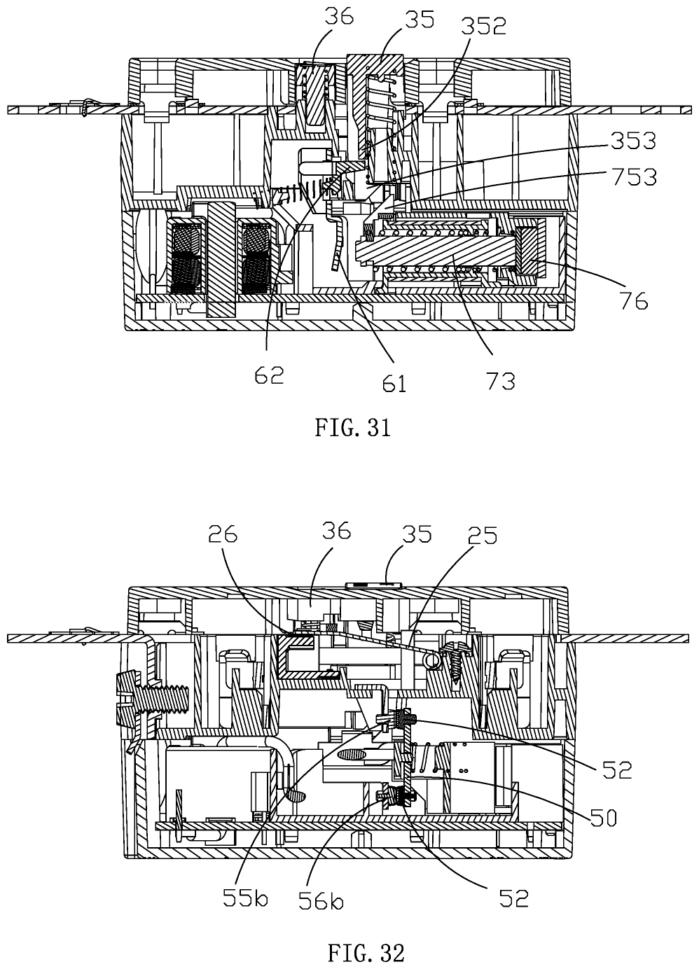

As shown in FIGS. 22-32, in the initial state, the iron core 73 inside the coil 72 (solenoid) maintains a certain distance from the permanent magnet 76 and does not touch it, and the terminal end of the lower end of the rotating piece 61 is arranged against the iron core 73 (there is no attractive force at this time). And, the contact silver points 52 on the left and right sides of the movable contact 50 are disengaged from the contact silver points 55b, 56b on the static contact 55a on the plug base 55 and the static contact 56a of the load connection end 56, respectively. In addition, in the state that the circuit interrupter is not electrified, the first locking member 62 on the first locking mechanism 60 blocks the pressing block 355 in the middle of the resetting key 35, so as to prevent the resetting key 35 from moving further downwards, and at the same time the blocking bar 29 on the base seat 20 hinders the first locking member 62 from continuing to rotate.

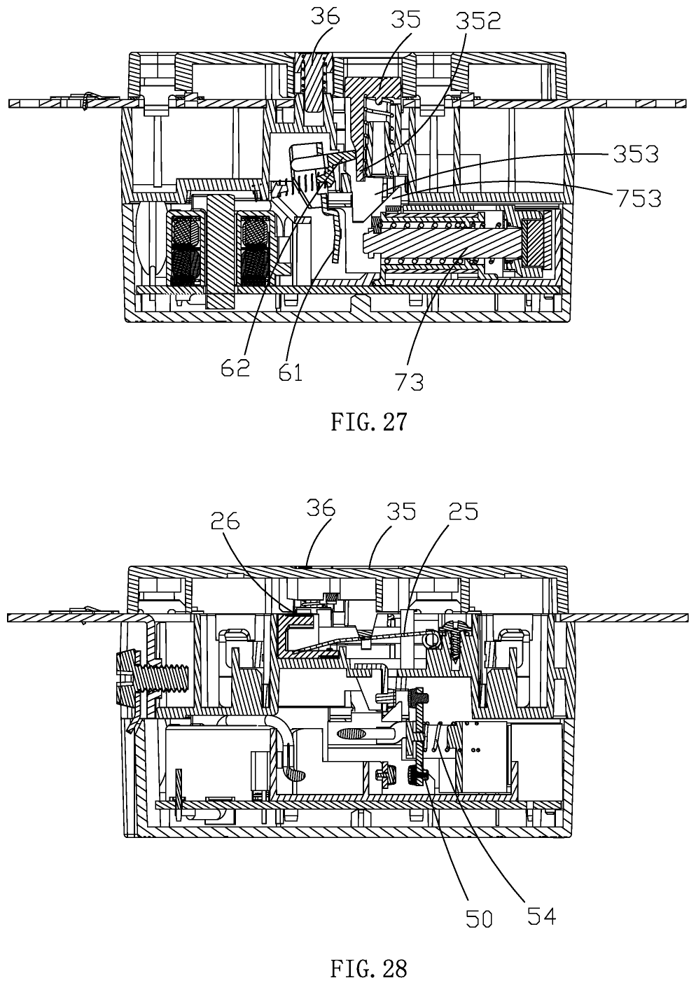

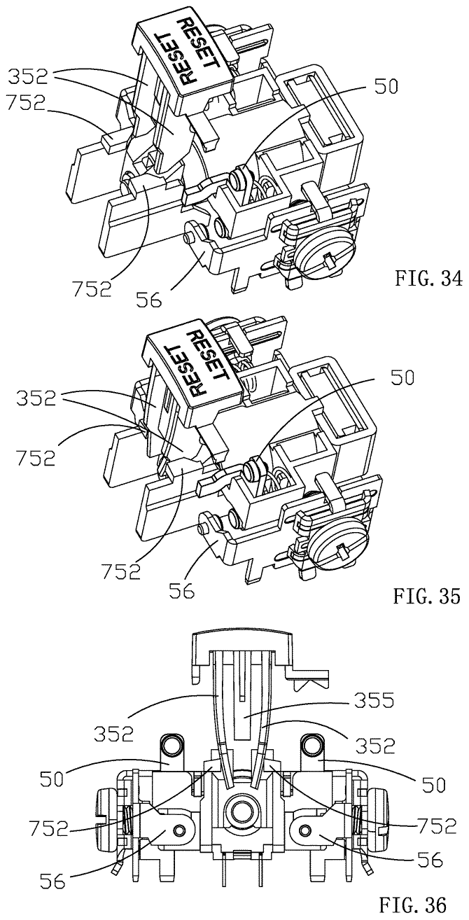

In the case that an operator makes a correct connection (both the live wire and the null line are correctly connected with a load end), he/she presses down the resetting key 35 with his/her finger, thus the resetting key 35 presses downwards the elastic electroconductive member 25 installed on the base seat 20, and the elastic electroconductive member 25 bends downwards and makes electrical contact with the electroconductive installation piece 26 arranged below it, meanwhile a control switch makes contact to make conduction in the control circuit; the IC chip (processor) on the control circuit board 90 sends out a signal to make the coil 72 conduct instantaneous current, and then make the iron core 73 generate magnetism, thus the iron core 73 will attract the end of the rotating piece 61, so that this end completely fits one end of the iron core 73, and then enables the rotating piece 61 to rotate around the rotating shaft 612 on it; the first locking member 62 installed on the rotating piece 61 compresses the spring 63 installed on it (the other end of the spring is fixedly installed on the supporting frame 21), and at the same time a repulsive force is generated between the permanent magnet 76 on the main frame 71 and the iron core 73, and remains static under the action of the restoring force of the spring 712 (because the spring 712 is compressed). Thus, the first locking member 62 gives a way and no longer blocks the pressing block 355 on the resetting key 35, so that the resetting key 35 continues to move downwards until the oblique planes 353 at the ends of the two pressing rods 352 on the resetting key 35 respectively touches the oblique plane on the bump 753 on the middle position of the horizontal sliding member 75, at this moment, the stopping block 752 on the horizontal sliding member 75 is not in contact with the corresponding pressing rod 352 and away a certain distance from it, as shown in FIG. 34. This reset key 35 is further pressed downwards, and the oblique planes of the ends of two pressing rods 352 on this reset key 35 push the oblique plan on the bump 753 on the horizontal sliding member 75, so as to move the horizontal sliding member 75, at this moment, in the process of moving, the stopping block 752 on the horizontal sliding member 75 gradually presses the two pressing rods 352 on the resetting key 35 respectively, so that the two pressing rods 352 are deformed and close to each other. At the same time, the iron core 73 fixedly connected with the horizontal sliding member 75 moves towards the permanent magnet 76, and further compress the spring 732 until the iron core 73 is attracted by the permanent magnet 76 and does not move, as shown in FIGS. 27-28. At this moment, the stopping block 752 on the horizontal sliding member 75 blocks the two pressing rods 352 on the resetting key 35 to a maximum extent, respectively, that is, the maximum deformation occurs to the two pressing rods 352, as shown in FIGS. 35-36.

After the resetting key 35 is released, it moves upwards and returns to its initial position under the force of the spring, and the two pressing rods 352 also elastically return to their initial state; the oblique planes 353 at the ends of the two pressing rods 352 on the resetting key 35 is respectively disengaged from the oblique plane on the bump 753 on the middle position of the horizontal sliding member 75, and the horizontal sliding member 75 and the iron core 73 drive the main frame 71 to move to the left together under the restoring force of the spring 732 due to the release of external force, at this moment, the iron core 73 and the permanent magnet 76 maintain their contact due to the attraction between them, and the spring 712 inside the main frame 71 is compressed. As the main frame 71 moves to the left, the movable contacts 50 on both sides of the main frame 71 also concurrently move to the left, so that the contact silver points 52 at the upper and lower ends of the movable contact 50 are electrically connected to the contact silver points 55b on the static contact 55a of the plug base 55 and the contact silver point 56b on the static contact 56a of the load connection end 56, respectively. Moreover, the movable contact 50 is elastically arranged against the spring 54 simultaneously, so this elastic contact structure is simple, firm and reliable.

Furthermore, the stopping blocks 752 (or called a second locking member) on both sides of the horizontal sliding member 75 blocks the terminal plane 358 (see FIG. 16) of the pressing rod 352 on the resetting key 35, respectively, so as to hinder the pressing rod 352 of the resetting key from moving downwards and lock the resetting key 35, thereby preventing someone from mistakenly pressing the resetting key 35 to cause the ground fault circuit interrupter to break contact, and avoiding the normal operation of the electrical equipment on the whole circuit and people's normal activities from being affected and the electrical equipment from being damaged.

After an operator presses down the test key 35 (TEST key), thus the test key 35 presses downwards the elastic electroconductive member 25, and the elastic electroconductive member 25 bends downwards and makes electrical contact with the electroconductive installation piece 26, so as to make conduction in the entire control circuit; the IC chip on the control circuit board 90 sends out a signal to make the coil 72 conduct instantaneous current, and then make the iron core 73 generate magnetism; the electromagnetic force (a repulsive force) is greater than the attractive force of the permanent magnet 76 to the iron core 73, so the electromagnetic force overcomes the attractive force of the permanent magnet 76 and pushes the iron core 73 to move to the left away from the permanent magnet 76, at this time the iron core 73 returns to its initial position again and is arranged against the terminal end of the rotating piece 61; at the same time, while the main frame 71 are returning to its initial position under the action of the electromagnetic force and the restoring force of the spring 712, the contact silver points 52 of the upper and lower ends of the movable contact 50 are respectively disengaged from the contact silver point 55b on the static contact 55a of the plug base 55 and the contact silver point 56b on the static contact 56a of the load connection end 56, after this the movable contact 50 returns to its initial position under the restoring force of the spring 54. Furthermore, the stopping blocks 752 (or called a second locking member) on the two sides of the horizontal sliding member 75 respectively give a way for the pressing rod 352 on the resetting key 35, so they no longer hinder the pressing rod 352 from moving downwards, so that the resetting key 35 can continue to move downwards, at this moment, the circuit interrupter breaks contact, as shown in FIGS. 22-32.

It is understandable that the ground fault circuit interrupter of the present invention can also be connected to an indicator light, such as a light-emitting diode LED. The springs mentioned in the present invention can also be replaced with other clastic elements, not limited to this.

In the more stable and reliable ground fault circuit interrupter provided by the present invention, the iron core moves linearly in the solenoid, and interacts with the horizontal sliding member, the main frame, the movable contact fixed on the main frame and a plurality of springs together while driving the movable contact to move, so as to enable the grounding fault circuit interrupter to make contact and break contact; in the process from breaking contact to making contact, the force applied by the operator's hand generates movement, and the permanent magnet in a make-contact state maintains a contact force; in the process from making contact to breaking contact, the electromagnetic force generated by the electrified solenoid is greater than the attractive force of the permanent magnet to the iron core, so as to make the iron core and the main frame provided with the movable contact move relative to each other, so that the contact silver points 52 at the upper and lower ends of the movable contact 50 are disengaged from the contact silver point 55b on the static contact 55a of the plug base 55 and the contact silver point 56b on the static contact 56a of the load connection end 56, respectively.

At a break-contact position, because the end of the rotating piece is arranged against the iron core, the distance between the rotating piece capable of rotation and the iron core is close to zero, thereby reducing magnetic resistance. Then, press the resetting key to move down, enabling the resetting key to press downwards the clastic electroconductive member and make it contact the electroconductive installation piece, at this moment, the coil is electrified, and the iron core generates magnetism and attracts the rotating piece to rotate, so the first locking member hindering the resetting key from moving downwards gives a way to downward movement for the resetting key; in this process, no displacement occurs to the iron core and the horizontal sliding member. When the ground fault circuit interrupter is in a break-contact state, if the input end and the load end are connected up incorrectly, the coil cannot be electrified, thus the resetting key is blocked by the first locking member, and the first locking member is blocked by the blocking bar on the base seat, so it cannot continue to move down, neither push the horizontal sliding member.

In the ground fault circuit interrupter provided by the present invention, as the magnetism-collecting piece is added and the magnetic permeable piece is bent and designed to be arc-shaped, such structure can reduce magnetic resistance, greatly decrease the volume of the permanent magnet and lower costs.

In the case that the ground fault circuit interrupter is at a make-contact position, there is a stopping block on the horizontal sliding member to hinder the resetting key from sliding downwards. This feature ensures stable and reliable contact of the ground fault circuit interrupter (GFCI) and prevents accidental contact with the resetting key during use, thereby making the contact force smaller (poor contact, ignition); it also ensures that the resetting key does not slide downwards to push the control circuit switch, if the control circuit switch is on, it will electrify the coil and cause the ground fault circuit interrupter (GFCI) to break contact. In addition, the present invention realizes that the contact silver points at two ends of the movable contact are respectively connected to or disengaged from the contact silver point on the plug base and the contact silver point on the load connection end by way of pushing the main frame to drive the movable contact to move horizontally, so such contact is firm, safe and reliable.

In addition, the ground fault circuit interrupter of the present invention only needs a tripping mechanism used to break contact, and an operator presses the resetting key by hand to make contact, which is formed through mechanical interaction. Furthermore, the magnetic permeable piece is designed to bending, which narrows down the magnetic gap, and the magnetism-collecting piece is added to greatly raise an attraction force, but the identical attraction force only requires a smaller magnet.

The ground fault circuit interrupter of the present invention has the advantages such as reverse connection-proof function, no occurrence of electrifying sockets on the panel at the time of reversing connection, rapid tripping, strong anti-interference, operational convenience, structural reasonability and low costs.

The above description is only preferred examples of the present invention, and does not pose any limitations on the protection scope of the present invention, and any equivalent structures or equivalent variations made based on the contents of the description and drawings of the present invention, or by way of directly or indirectly applying the contents in other related technical fields, fall within the protection scope of the present invention for the same reason.

What is claimed is:

1. A ground fault circuit interrupter comprising:
a lower cover;
an upper cover;
a base seat arranged between the lower cover and the upper cover, and comprising a supporting frame, wherein the ground fault circuit interrupter further comprises a tripping mechanism, a resetting key, a test key, a pair of movable contacts having contact silver points and elastically move, a pair of first static contacts having silver contacts and are fixed on said base seat, a pair of second static contacts having silver contacts and are fixed on said supporting frame, a first locking mechanism and a control circuit board;
said tripping mechanism comprises an elastically-movable main frame, a first spring, a coil fixing frame connected to said main frame by means of said first spring, a coil encircling said coil fixing frame, an iron core arranged inside said coil fixing frame and said coil, a horizontal sliding member fixedly connected with one end of said iron core, a permanent magnet arranged on the other end of said main frame, and a magnetic permeable piece surrounding said permanent magnet; said movable contacts are elastically installed on said main frame, and the contact silver points on said movable contacts are elastically connected to or disengaged from the contact silver points on said first static contacts and the contact silver points on said second static contacts, respectively;
said first locking mechanism comprises a rotating piece rotatably arranged on said supporting frame and a first locking member rotatably installed on said rotating piece; one end of said first locking member is used to block said resetting key and the other end is provided with an elastic element; when said first locking member is at a blocking position, said first locking member stops said resetting key from moving downwards; when said coil conducts instantaneous current, said iron core generates magnetism and attracts said rotating piece to rotate, while said rotating piece is rotating, said rotating piece drives said first locking member to rotate and gives a way for said resetting key, said resetting key continues to move downwards and pushes said horizontal sliding member, thus said horizontal sliding member moves horizontally and compresses a second spring encircling said iron core and causes said permanent magnet to attract said iron core; at the time of removing the pressure on said resetting key, said horizontal sliding member drives said main frame to move under the restoring force of said second spring encircling said iron core, and causes said movable contacts to move, so as to make electrical contact with the contact silver points on said first static contacts and said second static contacts, respectively.

2. The ground fault circuit interrupter according to claim 1, wherein said resetting key comprises at least one pressing rod having an oblique plane, when the pressing rod pushes said horizontal sliding member to move, a second locking member arranged on said horizontal sliding member presses the said pressing rod to deform; at the time of removing the pressure on said resetting key, said resetting key returns to an initial position, so said second locking member stops said pressing rod from moving downwards.

3. The ground fault circuit interrupter according to claim 1, wherein a protrusion blocking and restricting said first spring and said second spring is arranged inside said coil fixing frame.

4. The ground fault circuit interrupter according to claim 1, wherein both said resetting key and said test key are sleeved with an elastic element that makes said resetting key and said test key return to their initial position.

5. The ground fault circuit interrupter according to claim 2, wherein said horizontal sliding member further comprises a bump having an oblique plane that fits with said pressing rod of said resetting key.

6. The ground fault circuit interrupter according to claim 2, wherein said resetting key comprises a flat for an operator's finger to press, said pressing rods having an oblique plane are respectively arranged on both sides below said flat, a pressing block is arranged between said two pressing rods, and said pressing block presses said first locking member.

7. The ground fault circuit interrupter according to claim 1, wherein an accommodating groove is arranged on said main frame, and said movable contacts are elastically arranged inside said accommodating groove.

8. The ground fault circuit interrupter according to claim 1, wherein said tripping mechanism further comprises a magnetism-collecting piece closely attached to said permanent magnet, said magnetic permeable piece surrounds said permanent magnet and said magnetism-collecting piece, and said magnetic permeable piece has a bending structure and an arc-shaped structure.

9. The ground fault circuit interrupter according to claim 1, wherein said first static contacts are arranged on a plug base; said second static contacts are arranged on a load connection end.

10. The ground fault circuit interrupter according to claim 1, further comprises an elastic electroconductive member and an electroconductive installation piece positioned below said elastic electroconductive member, said the test key or said resetting key presses downwards said elastic electroconductive member, then said elastic electroconductive member moves downwards and makes electrical contact with said electroconductive installation piece, so as to make conduction in an entire control circuit on said control circuit board; thus a chip on said control circuit board sends out a signal to make said coil conduct instantaneous current, and then make said iron core generate magnetism.
